(19) United States
(12) Patent Application Publication
(10) Pub. No.: US 2015/0133131 A1
(43) Pub. Date: May 14, 2015

(54) Accessing Mobile Communication Resources

(71) Applicant: Nokia Siemens Networks Oy, Espoo (FI)

(72) Inventors: Vinh Van Phan, Oulu (FI); Kari Veikko Horneman, Oulu (FI)

(21) Appl. No.: 14/117,905

(22) PCT Filed: May 18, 2011
(86) PCT No.: PCT/EP2011/058080

§ 371 Date: Nov. 15, 2013

(51) Int. Cl. H04W 72/04

(52) U.S. Cl. CPC H04W 72/04
USPC 455/450

(57) ABSTRACT

Methods and apparatuses for providing access to communication resources in the area of a first access system are disclosed. In a method information is received from at least one device in the area of the first access system, where after it is determined, based on the information, whether at least one mobile device in the area is capable of providing access to communication resources via a second access system. Upon selection of at least one mobile device information is sent to the at least one mobile device for configuration thereof as an access point to communication resources via the second access system. The information is received at the mobile device where after it is configured accordingly for use by other devices for accessing communication resources via the second access system.

This disclosure relates to mobile communications, and more particularly to providing mobile devices with access to communication resources.

Mobile communication can be provided by means of a wireless system. A wireless system can be seen as a facility that enables communications over an air interface between two or more wireless devices such as fixed and/or mobile communication devices, access nodes such as base stations, relay nodes, and/or other devices capable of wireless communication. A communication device is provided with an appropriate signal receiving and transmitting arrangement for enabling communication of voice, data and signalling with other parties. A wireless communication device of a user is often referred to as user equipment (UE) or terminal. Examples of wireless systems include public land mobile networks (PLMN) such as cellular networks, satellite based communication systems and different wireless local networks. Examples of PLMN systems include architectures standardized by the 3rd Generation Partnership Project (3GPP). These include the Universal Mobile Telecommunications System (UMTS) and the long-term evolution (LTE) of the Universal Mobile Telecommunications System (UMTS). A further development of the LTE is often referred to as LTE-Advanced. Examples of wireless local area networks (WLAN) providing access points include systems such as those based on IEEE 802.11 standards. Another example is broadband wireless metropolitan area networks, such as those based on IEEE 802.18 standards. Device to device (D2D) communication between user devices is also known.

It is often desired to increase the spatial density of the access nodes. This may be desired, for example, to satisfy increased mobile traffic demand, either temporarily or permanently. Examples of possible topologies providing more capacity include femto access cells and other local or short range networks. A radio access node is a key point of such topologies. A possibility is to provide a short range access point by means of a mobile device capable of communicating via a cellular system and also via an Internet Protocol based system. Such an access node may have limited complexity, and therefore any advanced control functions such as dynamic access control may be prohibitive. However, it may be desired to be able to control efficient use of resources provided by femto cells provided by devices that may not be available all of the time.

It is noted that the above discusses only examples, and the issues are not limited to any particular communication system, standard, specification, radios and so forth, but may occur in any communication device and/or system.

In accordance with an embodiment there is provided a method for providing access to communication resources in the area of a first access system, the method comprising receiving information from at least one device in the area of the first access system, determining based on the information whether at least one mobile device in the area is capable of providing access to communication resources via a second access system, and sending information to the at least one mobile device for configuration thereof as an access point to communication resources via the second access system.

In accordance with an embodiment there is provided a method for providing access to communication resources, the method comprising sending information from a mobile device providing access to communication resources via a first access system for use in determination of the suitability of the mobile device to provide access via a second system, receiving information for configuration of the mobile device as an access point for the access via the second access system, and configuring the mobile device accordingly for use by other devices for accessing communication resources via the second access system.

In accordance with an embodiment there is provided an apparatus for controlling access to communication resources by devices in a first access system, the apparatus comprising at least one processor, and at least one memory including computer program code, wherein the at least one memory and the computer program code are configured, with the at least one processor, to determine based on information received from at least one device in the area of the first access system whether at least one mobile device in the area is capable of providing access to communication resources via a second access system, and cause sending of information to the at least one mobile device for configuration thereof as an access point for mobile devices via the second access system.

In accordance with yet other embodiment there is provided an apparatus for controlling access to communication resources, the apparatus comprising at least one processor, and at least one memory including computer program code, wherein the at least one memory and the computer program code are configured, with the at least one processor, to cause sending of information from a mobile device providing access to communication resources via a first access system for use in determination of the suitability of the mobile device to provide access via a second system, receive information for configuration of the mobile device as an access point via the second access system, and configure the mobile device accordingly for use by other devices for accessing communication resources via the second access system.

In accordance with a more specific embodiment the determining comprises monitoring for mobile devices that are suitable for providing the access point, and selecting by a controller associated with the first and/or the second access system at least one mobile device for use as an access point for other devices based on a predefined criteria.

Information can be sent from a mobile device in response to detection that the mobile device is connected to an Internet Protocol access port and/or is in on-line state via the second access system and/or is connected to an appropriate power supply.

The first access system may comprise a mobile communications system operated in accordance with a cellular protocol. The second access system may comprise a data system operated in accordance with a data communications protocol. The second access system may provide Internet Protocol connections.

Information communicated from a mobile device may comprise an indication regarding the status of connection of the mobile device to the second access system, information regarding the power capabilities of the mobile device, information regarding the radio environment of the mobile device and/or data network access by the mobile device, information regarding public land mobile network identity, type of the radio access, cell identity, spectrum allocation, spectrum load sensing parameter, an Internet Protocol address, subnet information, Internet service provider, detected available bandwidth, Internet Protocol connection data rate, power supply source and/or type, remaining capacity of a battery, and/or information associated with the location of the mobile device.

A timer apparatus may be triggered in response to detection of a change in the access provided by the mobile device. Radio operation of the mobile device can be maintained until expiry of the timer apparatus. A further timer apparatus may be provided and triggered in response to expiry of the timer apparatus. The radio operation of the mobile device is maintained after the trigger of the further timer apparatus is triggered whilst preparation for handover from the mobile device is performed.

A device comprising an apparatus configured to provide at least one of the embodiments can also be provided. The device may comprise a communication device such as a smartphone, a laptop or a tablet computer.

A computer program comprising program code means adapted to perform the herein described methods may also be provided. In accordance with further embodiments apparatus and/or computer program product that can be embodied on a computer readable medium for providing at least one of the above methods is provided.

Various other aspects and further embodiments are also described in the following detailed description of examples embodying the invention and in the attached claims.

The invention will now be described in further detail, by way of example only, with reference to the following examples and accompanying drawings, in which:

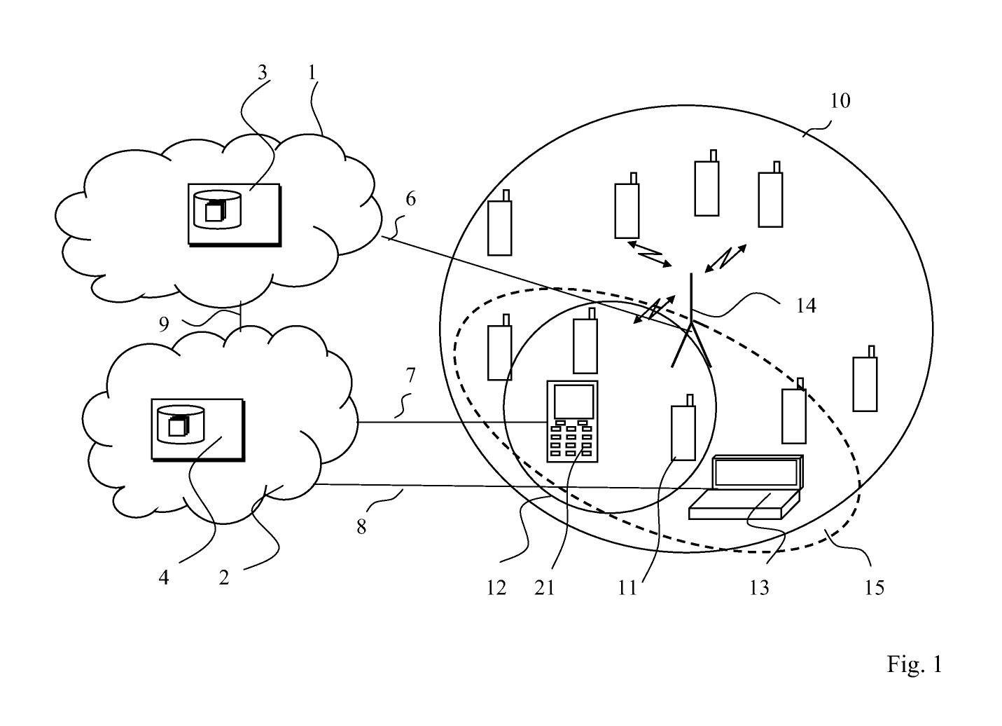

FIG. 1 shows an example of a system wherein certain embodiments of the invention may be implemented;

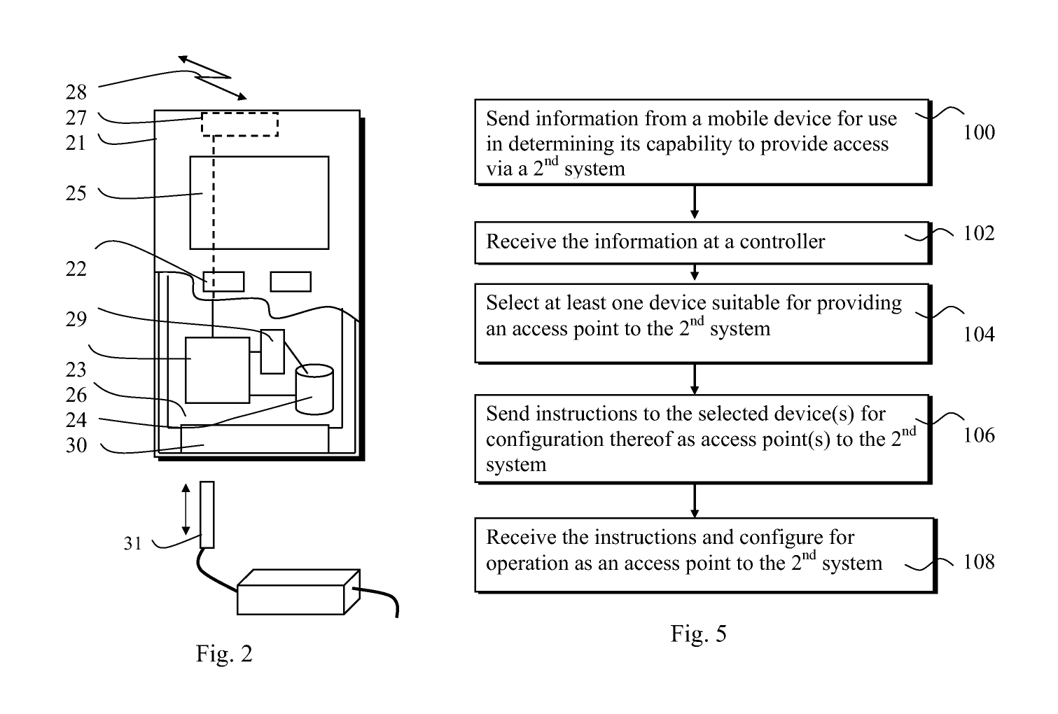

FIG. 2 shows an example of a communication device;

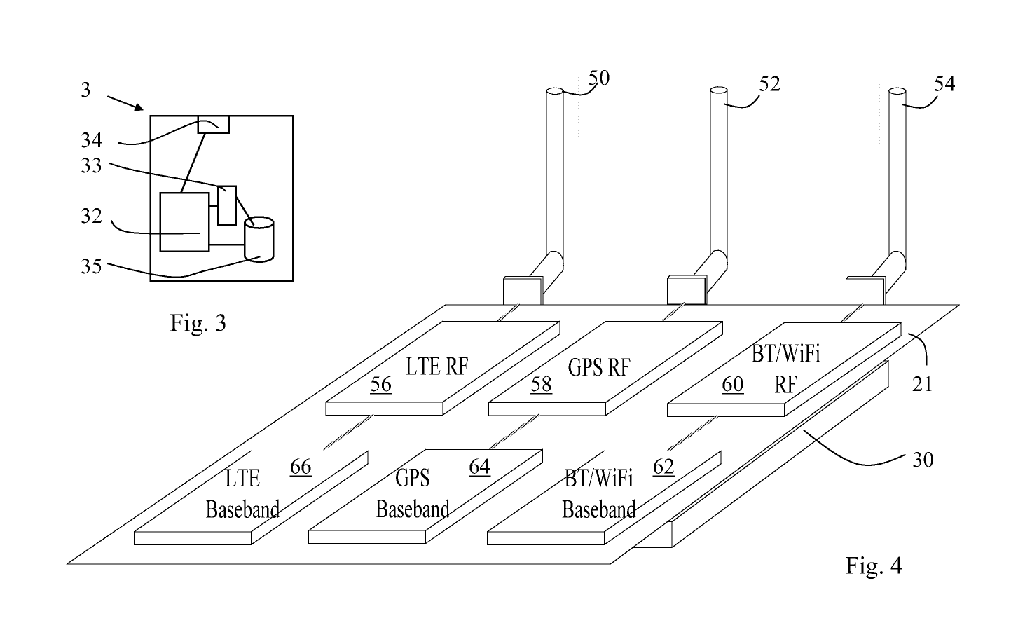

FIG. 3 shows an example of a controller apparatus;

FIG. 4 shows another example of a communication device;

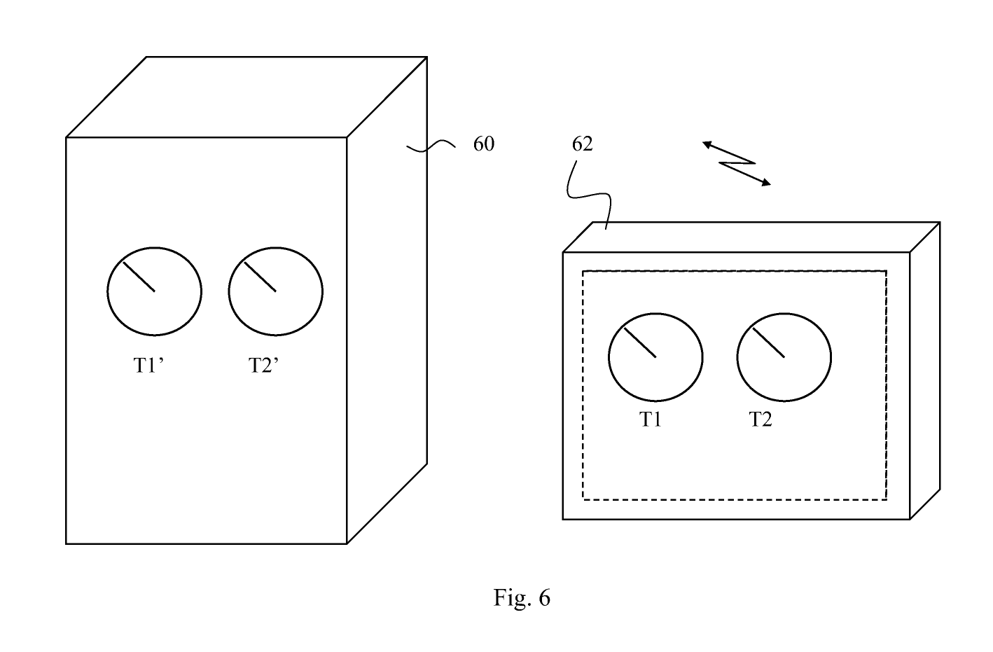

FIG. 5 is a flowchart in accordance with an embodiment; and

FIG. 6 shows an embodiment.

In the following certain exemplifying embodiments are explained with reference to a wireless communication system serving devices adapted for wireless communications with at least one other node. Therefore, before explaining in detail the exemplifying embodiments, certain general principles of a wireless system, components thereof, and devices for wireless communication are briefly explained with reference to the arrangement of FIG. 1, devices of FIGS. 2 and 4 and control apparatus of FIG. 3 to assist in understanding the technology underlying the described examples.

A wireless communication device adapted for mobile communications can be provided with wireless access to a communication system via at least one base station or similar access node. An access node may be provided by any node enabling a device to access a communication system. In FIG. 1 access node 14 provides a first radio service area, or cell 10, of a first access system. The base station is schematically shown to be linked by connection 6 to a cellular communication network 1. It is noted that a great number of service areas may be provided in a cellular system and that a communication device may simultaneously be located in a plurality of service areas. In a cellular system radio access is controlled by at least one appropriate controller so as to enable communications by the mobile communication devices via the access node. The control apparatus can be interconnected with other control entities. The control apparatus and functions may be distributed between a plurality of control units.

Mobile communication devices may also be provided radio access through local wireless access nodes, or access points (AP). The local access point can be provided, for example by a femtocell 12. A femtocell provides a type of a cellular base station functionality that is designed to operate over a relatively short range compared to a conventional cellular bases station. The idea of a short-range base station is to cover a relatively small geographical area which is expected to experience a high density of users and/or regular usage. For example, femtocells can be deployed in environments such as offices and cafes, public places like shops, shopping malls, station and airports, homes and outdoor locations, for example parks and/or other areas where the density of users may become relatively high. In the herein described examples a femtocell is provided by at least one of mobile devices 21 and 13. The mobile devices can be configured to act as a local device-to-device (D2D) relays.

A communication device within the area of the first access system may thus also communicate via another access system. In the example of FIG. 1 such access is schematically shown by logical connections 7 and 8 between devices 21 and 13 and a data network 2. The data network may be provided in accordance with the Internet Protocol (IP). The secondary access can be provided over the air or via a fixed line connection between the local access point and the data network.

It is noted that FIG. 1 shows only the connections between the access points and the respective communications systems. A device in a cell can be provided with a connection to a data network in various manners. For example, the secondary connections can also be routed via the physical base station or then the secondary access may be provided by means of additional, local base stations, for example a WLAN station, or via a fixed line connection, for example Asymmetric Digital Subscriber Line (ADSL). In accordance with a specific example a laptop or tablet computing device equipped with suitable 3GPP radios and a regular fixed plug-in IP port can be used to provide the primary and secondary connections. When such devices are present for example in a populated in-door environment where power-supply and fixed plug-in IP access is available and accessible these users may be plugged in to both the power supply and the fixed IP access port and potentially be selected and reconfigured to work as a femto access point for local mobile cellular users. Regardless whether the secondary access is provided via IP access over a WLAN or a fixed line connection, a controller selecting a suitable access points is configured to considerer that a terminal device to be selected and reconfigured to work as femto AP should have a non-cellular or out-band IP access backhaul connection and a reliable power supply in place. More detailed examples for controlling the access via the second access system are described later.

FIG. 1 shows also a controller apparatus for selection and control of such access points. The controller may be provided in association with the cellular system 1 serving the cellular user devices 11, 13 and 21. This possibility is shown by controller 3. The controller 3 may be provided as a part of the serving cellular network functionalities, for example implemented as an extended functionality of an operation and management (OAM) server or another network control server such as a mobility management entity (MME) or a location registration and control server. Terminal devices served by the base station 14 may report various information to the controller 3. For example, information regarding power-supply capabilities and/or non-cellular IP access to the serving cellular network can be reported and considered by the controller 3 as an extended procedure of relevant cellular networks.

The controller 3 may be configured to authenticate and authorize the devices for such reporting, either over the cellular access via the macro base station 14 or via an existing non-cellular Internet Protocol (IP) access, see connections 7 and 8. The cellular option may be preferred in occasions where a reporting device does not have a prior knowledge about the IP address of the controller.

The relevant controller apparatus in the serving cellular network can establish and maintain a table of potential access point candidate devices per location. According to a possibility a table of potential devices is defined beforehand and the controller apparatus monitors only for on-off availability of the devices in the table.

According to a possibility also shown in FIG. 1 such as controller is provided in the data network 2, this being shown as controller 4. The controller may also be provided as a third-party server which acts as a coordinator for femto-operating cellular networks. In such as scenario potential access point candidates may be provided beforehand with information regarding where to initiate and send the reports to. The reporting can be authenticated and protected for security reason.

A communication device can thus be selected to operate as a femto access point. Such access point can be considered as providing a local cell of the serving cellular network or a third-party system, and all calls via this device over the femto access can be considered as cellular services provided by the serving cellular network. Such calls may be routed back to the serving network 1, or to a serving femto gateway. According to a possibility an optimized local-IP breakout solution is provided that allows for routing at least user-plane IP packets on the shortest paths to the destination.

FIG. 2 shows a schematic, partially sectioned view of a communication device 21 that a user can use for communications. Such a communication device is sometimes referred to as user equipment (UE) or terminal. An appropriate mobile communication device may be provided by any device capable of sending and receiving signals. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia, positioning data, other data, and so on. Users may thus be offered and provided numerous services via their communication devices. Non-limiting examples of these services include two-way or multi-way calls, data communication or multimedia services or simply an access to a data communications network system, such as the IP based Internet.

A communication device is typically provided with at least one data processing entity 23, at least one memory 24 and other possible components 29 for use in software and hardware aided execution of tasks it is designed to perform, including control of access to and communications with base stations and other devices. The data processing, storage and other relevant control apparatus can be provided on an appropriate circuit board and/or in chipsets. This feature is denoted by reference 26. Control and memory functions provided by the control apparatus of the mobile device in view of operation in accordance with certain embodiments of the present invention will be described later in this description.

The user may control the operation of the mobile device by means of a suitable user interface such as key pad 22, voice commands, touch sensitive screen or pad, combinations thereof or the like. A display 25, a speaker and a microphone are also typically provided. Furthermore, a mobile communication device may comprise appropriate connectors (either wired or wireless) to other devices and/or communication interfaces and/or for connecting external accessories, for example hands-free equipment, thereto.

The device 21 may receive and transmit signals 28 via appropriate apparatus for receiving and transmitting signals. In FIG. 2 transceiver apparatus is designated schematically by block 27. The transceiver may be provided for example by means of a radio part and associated antenna arrangement. The antenna arrangement may be arranged internally or externally to the mobile device. A wireless communication device can be provided with a Multiple Input/Multiple Output (MIMO) antenna system. The communication device can be provided with a multiple of coexisting radios in order to allow users to access various networks and services ubiquitously. For example, a wireless device can be equipped with multiple radio transceivers. In accordance with a more particular example a mobile device may be equipped with a cellular radio (e.g. LTE), a wireless local area network (e.g. WiFi™), and a short range radio (e.g. Bluetooth™) transceivers, and global navigation satellite system (GNSS) receivers. A more detailed example of possible coexisting radio components is shown in FIG. 4.

A mobile device is also provided with power supply 30, typically a rechargeable battery. The battery can be charged by connecting the device to a charger 31, for example via a charging port. A charger can be connected to the device also when the device is in use.

FIG. 3 shows an example of a control apparatus 3 for controlling access by mobile devices via local short range access points. The control apparatus can be, for example, coupled to and/or for controlling a station of a radio service area or located elsewhere in the cellular system and be managed by the cellular operator. In accordance with a possibility the control apparatus is provided by a third party service provider via the data network 2. The control apparatus can be arranged to provide control on receiving and processing information received from mobile devices, for determining at least one suitable device for operating as an access node and for sending instructions to mobile devices. For providing the operation, the control apparatus can comprise at least one memory 35, at least one data processing unit 32, 33 and an input/output interface 34. Via the interface the control apparatus can be coupled to relevant entities. The control apparatus can be configured to execute an appropriate software code to provide the control functions.

In order to allow users to access various networks and services ubiquitously, a communication device can be equipped with multiple coexisting radio transceivers. The radios can be out of band so that unnecessary interference is avoided. In the example of FIG. 4, a device 21 has a first antenna 50, a second antenna 52 and a third antenna 54. The first antenna 50 is configured to transmit and receive LTE signals. The second antenna 52 is configured to receive GPS (global positioning system) signals. The third antenna 54 is configured to transmit and receive Industrial, Scientific and Medical (ISM; this can include technologies such as the Bluetooth™ and WLAN, for example Wi-Fi™) signals. The first antenna 50 is connected to an LTE radio frequency processor 56 which is arranged to process the radio frequency signals. The LTE radio frequency processor 56 is coupled to an LTE baseband processor 66 which is arranged to process the radio frequency signals to convert those signals to the baseband and to process those signals. Similarly, the second antenna 52 is coupled to a GPS radio frequency processor 58, which is arranged to be coupled to the GPS baseband processor 64. Finally, the third antenna 54 is connected to a Bluetooth™/Wi-Fi™ radio frequency processor 60 which in turn is connected to the Bluetooth™/Wi-Fi™ baseband processor 62. It should be appreciated that when the respective antenna receives a radio frequency signal, that radio frequency signal is provided to the respective radio frequency processor. The radio frequency processor may carry out any suitable processes, for example, filtering the desired signal from the undesired signals and/or amplification. The processed radio frequency signal is then provided to the respective baseband processor for down-conversion to the baseband and further processing. In the case of transmission, the baseband processors will receive the signals at the baseband and up-convert those signals to the radio frequency. Other processing may be carried out by the baseband processors. Those radio frequency signals are then passed to the respective radio frequency processor. The processing carried out by the respective blocks can be performed by a single block or processor, or by more than two blocks or processors. The division of the processes between the blocks can of course be changed. For example, the RF processing block may, for example, in some embodiments perform the baseband conversion, at least one of converting down to the baseband or up-converting to the radio frequency. Separate processors and/or antennas may be provided in some embodiments for uplink and downlink. In some embodiments, at least one processor may be used for two or more different types of signal received from and/or to be transmitted by two or more antennas. A power supply 30 is also shown.

FIG. 5 is a flowchart in accordance with an embodiment for providing access to communication resources via different access systems. In accordance with the embodiment a mobile device providing access to communication resources via a first access system generates and sends at 100 to control apparatus information for use in determination the suitability of the mobile device in providing access via a second system. For example, the information can be communicated via the macro base station 14 of the cellular system 1 or via the second access system 2 of FIG. 1. The second access system 2 may provide for example an IP backhaul connection to the first serving cellular system 1 or a third-party hosting network. The second system may not be aware of the actual communications between the device and the serving/hosting and controlling cellular system. The control apparatus receives at 102 the information from the device. The control apparatus may also receive corresponding information from other devices in the area. The control apparatus can determine based on the received information at 104 whether at least one mobile device in the area is capable of providing access to communication resources via the second or backhauling access system, and select such at least one device as an access point for other devices in the vicinity. The control apparatus may cause at 106 sending of information to the at least one mobile device for configuration thereof as an access point for the other mobile devices. The relevant device(s) receive at 108 the instructions and configure themselves accordingly for use by other devices for accessing communication resources via the second access system.

The selection may be provided based on appropriate criteria and/or in response to reception of information indicating availability of a suitable device. The selection may be made based on determination that the mobile device indicates as being connected to the second access system. The decision may also be based on information regarding the power capabilities of the mobile device. For example, availability information may be sent from a mobile device in response to detection that the mobile device is connected to an Internet Protocol access port and/or is in on-line state and/or is connected to a power supply capable providing at least a predefined capacity.

Information may be communicated between the communication devices and the controller apparatus via the first and/or the second access system.

The following describes more detailed examples where one or more of mobile devices 13 and 21 can provide access points for cellular mobile devices 11 in the area of base station 14 of FIG. 1. The following particular example is described in relation to a 3GPP LTE-A compliant system where a femto-access based cognitive radio network (CRN) is provided. Femto-access domain coupled with possible direct device-to-device (D2D) communications is considered as a good example of access technologies which can be used for cognitive radio networks (CRNs).

The schematic network model presented in FIG. 1 utilizes mobile devices, for example appropriate smart phone 21 or laptop personal computer (PC) 13 platforms that are plugged in to connect to the Internet data network 2. Such devices have the potential of becoming femto access points of a particular hosting cellular network for mobile devices 11 in the vicinity thereof. The potential access point can be stationary, but this is not necessary.

To provide such a networking arrangement the hosting cellular system can be provided with a mechanism for detecting and selecting capable and suitable mobile devices. For example, a control apparatus 3 provided in association with the cellular network 1 can be configured to determine mobile devices that have appropriate plugged-in IP connection resources and power supplies. The IP-connection resources may be determined to be appropriate for example if a fixed digital subscriber line (DSL) based IP network is capable of providing a certain data rate for the communications. Security issues may also be taken into consideration, for example it can be considered if the Internet service provider (ISP) van be identified/authenticated based on the available information for the reasons of trust/security. In the case of WLAN backhaul factors such as radio conditions, data rate and WLAN provider information may be taken into account in the selection. The control apparatus 3 may then instruct reconfiguration of the selected one or more devices, for example 13 and/or 21 in FIG. 1, to operate as cognitive femto access point of a femto cell 12 or a femto cloud, assuming that communication services for the end-users of these devices can be provided via the plugged-in IP connections 7 and/or 8. These communication services can include services that are accessed via the cellular access provided by the base station 14. The following describes more detailed examples for facilitating such an ability of a hosting cellular system.

In accordance with an embodiment idle and active femto-capable communication devices 21 and 13 report information relating to plugged-in IP connections 7 and 8 and their respective power supplies. For example, when a femto-capable mobile device is plugged in into an access system providing access to the IP network 4 and power supply ports and becomes on-line, a relevant femto client of the terminal can be activated. In accordance with an example a smart power supply can be provided. For example, a power supply such as a charger or another component providing a power line connection between a device and a power grid may be configured to provide more advanced power status information for use in the selection. The activated client can send a report to a particular server of home/visited hosting cellular network or a third-party service provider over the plugged-in IP connection 7 or 8, or via the cellular connection 6.

The report can contain information such as detected surrounding radio environment. For example, the device can report information relating to public land mobile identity (PLMN ID), radio access technology (RAT), cell ID, spectrum allocations, spectrum load sensing parameters, and so forth. Information relating to the local IP access may also be reported. For example, information relating to IP addresses, sub-nets, internet service providers, detectable available bandwidths or IP connection data rates, and so forth may be reported. Information relating to local power supply can also be reported. For example, indication about power-supply source and/or type, whether the device is connected to a charger or other fixed power supply, capacity and expected life-time of battery can be provided. Other local information such as location information including extended location contexts may also be reported.

In accordance with an embodiment a femto-capable mobile device that is plugged-in into IP access can be either in cellular idle or active state. Idle and active cellular device reporting can be extended such that when the device is in the idle state, the device may report information relevant for the determination of its suitability, for example information about local IP access and power supply, to the selected cellular system along with next idle location update procedure. If the device is in the active state, the device may report to the serving cellular system along with e.g. capability indication, measurement reporting, and so on.

Periodical or event-triggered follow-up reporting of the information can also be provided. Both of these triggering options can be provided for reassurance or security enhancement.

In accordance with an embodiment the in network determination is deployed in formation and/or management of femto clouds. A femto cloud comprises a collection of femto access points and can be seen as a virtual multi-operator cellular access network. For example, in FIG. 1 devices 21 and 13 can form a femto cloud 15 denoted by the dashed line. A femto cloud can be configured to support service continuity, including handover, between femto cells provided by mobile devices forming the femto cloud. A femto cloud can be assigned a unique network identifier or indication different to other network identifiers. This unique network identifier for the femto cloud can be advertised to mobile devices by individual femto cells constituting the femto cloud and/or by a third party via suitable common signalling (e.g. broadcast system information), dedicated signalling or other suitable means. Individual femto cells constituting the femto cloud may also be a member of one or more other femto clouds. A femto cloud can have a common pool of radio spectrum for FSU (flexible spectrum use)-based cognitive radio access. Individual femto cells forming part of the femto cloud can be configured or reconfigured to also operate in this common pool of radio spectrum. Information about the common pool of spectrum used by the femto cloud may be advertised or indicated to devices in the same way as the unique identifier mentioned above. Formation of a femto cloud as a secondary network can happen in different ways. In accordance with a possibility formation of a femto cloud is initiated by the control apparatus 3 in the cellular system or a control apparatus in the data network. One example is that at least a part of the femto cloud is formed as a distributed self-organised network (SON). Individual femto cells can be configured based on information from the controller determining the suitability of the devices as access nodes. Invitations to join the cloud can be sent to femto cells detected nearby and/or a request to join the cloud can be sent to femto cells that have been detected nearby as belonging to a femto cloud.

In accordance with an embodiment a network reconfiguration of selected suitable femto-capable devices to operate as cognitive femto access points is provided to enable organic growth of a femto cloud and a virtual multi-operator FSU cellular access extension. Based on collective up-to-date information of reports received from stationary on-line femto-capable mobile terminals, hosting cognitive radio network (CRN) may select suitable terminals and reconfigure them to operate as cognitive femto access points of some femto-clouds.

The hosting network may learn to ensure fast and reliable selection of suitable terminals such that those terminals are coming with crowds in predictable patterns. For example, the determination may be based on utilisation of information such as information of certain kinds of mobile users, certain time intervals of days, certain places, certain locations or positions, and so on. In potential application scenarios of highly dynamic, populated urban places or hot-spots like large public or office building complexes, exhibition centres, museums, university campuses, railway stations or airports and the like, information about local officers, teachers, shop owners, or professional employees may be used. For example, employees is such places may be equipped with femto-capable mobile terminals and when being plugged-in at work during opening hours those terminals may potentially be selected to provide cognitive femto access to other local and visiting mobile users. Upon the network reconfiguration of a selected terminal as a cognitive femto access point the network can reactivate a mobile cellular client provided in the terminal for providing cellular services to the end user of the terminal over the plugged-in IP access. The reconfiguration procedure can be performed over the plugged-in IP access connection or over the suitable macro cellular access. The latter option may also include paging of the selected terminal if it is in idle state for a new cause.

In accordance with an embodiment network reconfiguration can also be provided in scenarios where femto-operating terminals are plugged out, at least temporality, from the IP access and power supply ports and thus become off-line. In general, the control apparatus in the hosting network may learn to avoid selecting an often plugged-in plugged-out terminal as this may cause negative experience to local users and network-instability.

Reconfiguration of femto-capable devices in situations where a selected device may plug out from IP access and power supply ports at anytime may be provided. The reconfiguration can be based on one or more timer. In such an arrangement at least one timer and timer operations may be provided at a device providing a local femto cell. The timers can be preconfigured or configured dynamically during the operation. The at least one timer may be controlled by the hosting or serving cellular network, for example by a femto controller located in a femto gateway or serving mobility management entity (MME) of a LTE based system. Corresponding at least one timer may be maintained at the controller in the network, for example a femto gateway/MME. The timers are provided so that a sudden event such as IP plug-out or disconnection of the device can be detected and appropriate action taken in response thereto. For example, the network side may indicate for a selected target cell(s) to prepare for a possible handover recovery of femto users and/or remove and release relevant femto contexts of the devices.

FIG. 6 shows schematically an embodiment a first timer T1 is provided in a communication device 62. In this example it is assumed that a tablet type device is selected to provide the local access point. A corresponding timer T1′ is provided at a controller 60 at the network side. The timers are provided to guard an event that the selected femto-operating device may become plugged out from IP access and/or sufficient power supply for example by accident. The device may nevertheless be plugged back in before T1 and/or T1′ expires. The expiry of T1 and T1′ can be set so that no recovery action is required from the end-users. Thus, during T1 the radio operation of the local femto cell can be maintained until the expiry.

A second set of timers T2 and T2′ can also be provided to guard possible recovery actions after the first set of timers T1 and T1′ expire. Before expiry of T2, the radio operation of the local femto cell can be maintained and users of the femto cell may be notified and handed over to primary target cells. In on-line operation certain neighbour cells can be selected as the primary target cells if handover occurs due to lost backhaul connection. This can be provided to speed up the handover operation of communication devices attached to a femto cell. The selection of the primary targets may depend on various criteria, for example the number of devices attached to the femto cell, service type of on-going traffic, capabilities of the primary target cells and so on. Different devices may be handed over different primary target cells.

A femto access node may also notify its neighbours including the aforementioned primary target cells about the disruption if over-the-air communications between them is enabled and facilitated for such purposes.

Upon expiry of T2 and T2′ all femto contexts can be released. An on-line mobile cellular client is deactivated, and the device may go back to a regular mode.

A plugged-out device may report about previous femto operations to home/visited networks or a third party service provider server as soon as it is connected to a serving network for the next time. This is to aid network monitoring functions of femto capable devices (for the purposes of e.g. charging, rewarding, reselecting, etc.).

In accordance with an embodiment information from other devices in the area of the first access system is considered when selecting one or more devices for use as backhauling access points. For example, reports by devices that have detected a capable device and/or regarding radio conditions can be considered.

The embodiments may enable formation of a cognitive femto cell or femto cloud, a virtual multi-operator flexible spectrum use (FSU) cellular access extension of the hosting cellular network, for providing organic-growth cellular access coverage. This in turn can be used for bringing cellular access for example to locations where high density of mobile users have gathered in a cost-effective and energy-efficient fashion. The herein described cognitive radio techniques including multi-operator flexible spectrum use (FSU) can be used, for example, to provide cellular access in locations where large crowds may be present. For mobile users the possibility of access via a femtocell or femtocloud has an advantage of potentially extending mobile coverage and/or capacity and improving access to free local contents and services. From the point of view of a mobile network operator there may be an advantage of potentially enhancing network capacity and performance and/or creating added values.

The required data processing apparatus and functions of a control apparatus, a mobile device and any other node or element may be provided by means of one or more data processors. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

An appropriately adapted computer program code product or products may be used for implementing the embodiments, when loaded or otherwise provided on an appropriate data processing apparatus, for example for causing determinations of suitability of the mobile devices based on information from the mobile devices and/or other conditions, selections, configurations and communications of information between the various nodes. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is noted that whilst embodiments have been described in relation to certain architectures, similar principles can be applied to other communication systems where multiple access may be desired. For example, this may be the case in application where no fixed access nodes are provided but both access systems are provided by means of mobile user equipment. Also, the above principles can also be used in networks where relay nodes are employed for relaying transmissions. Therefore, although certain embodiments were described above by way of example with reference to certain exemplifying architectures for wireless networks, technologies and standards, embodiments may be applied to any other suitable forms of communication systems than those illustrated and described herein. It is also noted that different combinations of different embodiments are possible. It is also noted herein that while the above describes exemplifying embodiments of the invention, there are several variations and modifications which may be made to the disclosed solution without departing from the spirit and scope of the present invention.

1-41. (canceled)

42. A method for providing access to communication resources, the method comprising:
sending information from a mobile device providing access to communication resources via a first access system for use in determination of the suitability of the mobile device to provide access via a second system,
receiving information for configuration of the mobile device as an access point for the access via the second access system, and
configuring the mobile device accordingly for use by other devices for accessing communication resources via the second access system.

43. A method according to claim 42, comprising sending the information in response to detection that the mobile device is connected to an Internet Protocol access port and/or is in on-line state via the second access system and/or is connected to an appropriate power supply.

44. A method according to claim 42, wherein the first access system comprises a mobile communications system operated in accordance with a cellular protocol and the second access system comprises a data system operated in accordance with a data communications protocol.

45. A method according to any claim 42, wherein the second access system provides Internet Protocol connections.

46. A method according to claim 42, wherein information communicated from a mobile device comprises at least one of
an indication regarding the status of connection of the mobile device to the second access system,
information regarding the power capabilities of the mobile device,
information regarding the radio environment of the mobile device and/or data network access by the mobile device.

47. A method according to claim 42, wherein the information communicated from the mobile device comprises at least one of public land mobile network identity, type of the radio access, cell identity, spectrum allocation, spectrum load sensing parameter, an Internet Protocol address, subnet information, Internet service provider, detected available bandwidth, Internet Protocol connection data rate, information about power supply source and/or type, remaining capacity of a battery, and information associated with the location of the mobile device.

48. A method according to claim 42, comprising controlling access via the mobile device by means of a control apparatus provided in association with a cellular network.

49. A method according to claim 42, comprising
triggering a timer apparatus in response to detection of a change in the access provided by the mobile device; and maintaining the radio operation of the mobile device until expiry of the timer apparatus.

50. A method according to claim 49, wherein, in response to expiry of the timer apparatus, the radio operation of the mobile device is maintained, a further timer apparatus is triggered, and preparations for handover from the mobile device are started.

51. A method for providing access to communication resources in the area of a first access system, the method comprising:
receiving information from at least one device in the area of the first access system, determining based on the information whether at least one mobile device in the area is capable of providing access to communication resources via a second access system, and sending information to the at least one mobile device for configuration thereof as an access point to communication resources via the second access system.

52. A method according to claim 51, wherein the determining comprises:
monitoring for mobile devices suitable for providing the access point; and
selecting at least one mobile device for use as an access point for other devices based on a predefined criteria.

53. An apparatus for controlling access to communication resources, the apparatus comprising at least one processor, and at least one memory including computer program code, wherein the at least one memory and the computer program code are configured, with the at least one processor, to
cause sending of information from a mobile device providing access to communication resources via a first access system for use in determination of the suitability of the mobile device to provide access via a second system,
receive information for configuration of the mobile device as an access point via the second access system, and
configure the mobile device accordingly for use by other devices for accessing communication resources via the second access system.

54. An apparatus according to claim 53, wherein said information is communicated from the mobile device in response to detection that the mobile device is connected to an Internet Protocol access port and/or is in on-line state via the second access system and/or is connected to an appropriate power supply.

55. An apparatus for controlling access to communication resources by devices in a first access system, the apparatus comprising at least one processor, and at least one memory including computer program code, wherein the at least one memory and the computer program code are configured, with the at least one processor, to:
determine based on information received from at least one device in the area of the first access system whether at least one mobile device in the area is capable of providing access to communication resources via a second access system, and
cause sending of information to the at least one mobile device for configuration thereof as an access point for mobile devices via the second access system.

56. A computer program comprising program code means adapted to perform the steps of claim 42 when the program is run on a data processing apparatus.
